(19) United States
(12) Patent Application Publication
(10) Pub. No.: US 2005/0033933 A1
(43) Pub. Date: Feb. 10, 2005

(54) Systems and methods for modifying disk drive firmware in a raid storage system

(76) Inventors: William A. Hetrick, Wichita, KS (US); Scott E. Hubbard, Wichita, KS (US)

Correspondence Address: LSI LOGIC CORPORATION, 1621 BARBER LANE, MS: D-106, MILPITAS, CA, 95035, US

(21) Appl. No.: 10/633,801

(22) Filed: Aug. 4, 2003

(51) Int. Cl. G06F 12/00

(52) U.S. Cl. 711/165; 711/114

(57) ABSTRACT

Systems and methods are provided for modifying firmware in a disk drive without risk of data loss in a RAID storage system by substantially preventing the RAID storage system from entering into a degraded mode during the firmware modification. In one embodiment, the RAID storage system includes a system disk drive designated for firmware modification and includes a second or proxy disk drive. A storage controller coupled to both drives may copy data from the system disk drive to the proxy disk drive. The controller may then disable the system disk drive and direct requests to the proxy disk drive. Once the system disk drive is disabled and its data copied, the storage controller may change firmware of the system disk drive. Following firmware modification, the controller may update data as needed on the system disk drive and may then enable the system disk drive to again process the requests.

### CROSS REFERENCE TO RELATED APPLICATIONS

This application is related to co-pending U.S. patent application Ser. No. 10/141,565 (filed May 8, 2002) and co-pending U.S. patent application Ser. No. 10/109,285 (filed Mar. 28, 2002), each of which is herein incorporated by reference.

### BACKGROUND OF THE INVENTION

1. Field of the Invention

This invention generally relates to modifying firmware within a disk drive of a Redundant Array of Independent Disks (“RAID”) storage system. More specifically the invention relates to systems and methods for using a proxy disk drive in the storage system until firmware is modified in a first disk drive of the storage system such that the storage system operation does not degrade.

2. Discussion of the Related Art

Modern storage systems typically comprise a plurality of computer disk drives for providing large quantities of computer storage. For example, a RAID storage system may utilize a plurality of computer disk drives to provide storage often for a network of host computer systems. The RAID storage management techniques generally provide improved reliability through redundancy—redundant information recorded on the disk drives to preclude loss of data due to loss of a disk drive in the system. RAID management techniques also provide improved performance through striping—distributing stored data over multiple disk drives so that storage and retrieval of the data may complete in less elapsed time by use of multiple disk drives operating in parallel. These modem storage systems frequently retain these computer disk drives within structures commonly known as JBODs (“just a box of disks”) which house disk drives as manageable disk drive sets.

In storing data, a storage system processes input/output (I/O) requests from one or more host computer systems such that the host computer systems may access and manipulate data on the individual disk drives. Interruptions in such storage system operations can correspondingly result in “down-time” for the host systems accessing the stored data. Since many host computer systems in “mission critical” applications cannot afford such down times, the storage system must be operational at all times.

Occasionally, however, individual disk drives within a storage system need modifications to incorporate different features. Disk drives typically include a control element that includes a processor programmed to provide desired features of the disk drive. Such features are programmed as software operable in the processor of the disk drive control element. Such software embedded within a device such as a disk drive is often referred to as firmware.

A disk drive may require a software/firmware modification that alters functionality of the disk drive to fix problems or to enhance operation of the disk drive. A firmware modification may include replacing or changing software presently within the disk drive or replacing or modifying parameters programmed in the firmware that control operation of the disk drive.

When a disk drive is in need of a firmware modification, the disk drive is presently removed from operation, or taken “off-line”, and processing of I/O requests directed to the disk drive is terminated until the disk drive becomes operational again. Such a firmware modification to a disk drive operating as part of a RAID storage system forces the storage system to operate in a degraded mode as though one disk drive of the array of drives has failed. While in degraded mode, the RAID storage system continues processing I/O requests using remaining disk drives within the storage system that include redundant information.

Although data integrity is maintained in a RAID storage system operating in a degraded mode, a potential for lost data exists if another disk drive fails. Since one disk drive is taken off-line and the storage system therefore is operating in degraded mode, there is insufficient redundancy information in the degraded mode system to withstand a failure of another drive. Accordingly, data could be lost if the degraded mode system fails while operating in degraded mode.

The risk of such a second failure causing loss of data is present for as long as the first drive remains off-line for the firmware modification process. Off-line time for a disk drive being so modified often depends on the difficulty and/or size of a particular firmware change. Additionally, the off-line time may depend on other factors such as the time to store and process the I/O requests to the disk drive. This off-line time is magnified when each disk drive of the storage system is scheduled to receive such firmware modifications in sequence. Such sequential firmware modifications in a storage system extend the duration of degraded capability making the storage system more vulnerable to lost data and/or data access interruptions. This risk of data loss in the storage system is often unacceptable in many business environments that demand high reliability and availability of the storage system. Accordingly, as evident from the above discussion, a need exists for improved structures and methods for modifying firmware in disk drives of a RAID storage system without substantially exposing the storage system to lost data and/or interruptions.

### SUMMARY OF THE INVENTION

The present invention solves the above and other problems, thereby advancing the state of useful arts, by providing methods and associated structures to modify firmware in a disk drive of a RAID storage system. More specifically, firmware in a primary disk drive is modified after data is copied from the primary disk drive to a replacement, or proxy, disk drive. I/O requests involving the primary disk drive may be temporarily directed to the proxy disk drive. Firmware that is presently within the primary disk drive may then be replaced and/or modified. After the firmware in the primary disk drive is modified, data from the proxy drive is copied to the primary disk drive and the primary disk drive is reintroduced to the storage system to begin processing I/O requests. In one embodiment, I/O requests which may affect the primary disk drive during the upgrade process may be logged so that only the affected portions of the primary disk drive need be recovered when the primary disk drive is again brought on-line. The proxy drive as described herein may be a “hot-swappable” spare disk drive or an unassigned drive within the storage system. Hot swappable disk drives, namely indicating that the drives may be used to replace other disk drives while a system is on-line, are known to those skilled in the art. Unassigned drives are drives that have no active role in volume configuration.

In one embodiment, a method of modifying firmware in a first disk drive of a RAID storage system comprises: copying data from the first disk drive to a second disk drive; redirecting requests to access the first disk drive to the second disk drive in response to copying the data; and changing firmware presently within the first disk drive in response to redirecting the requests.

In another embodiment, the method further comprises disabling the first disk drive from processing the requests while changing the firmware.

In another embodiment, the method further comprises enabling the first disk drive in response to changing the firmware.

In another embodiment, the method further comprises stopping the redirecting of the requests to the second disk drive in response to enabling.

In another embodiment, the method further comprises copying data from the second disk drive to the first disk drive in response to enabling the first disk drive.

In another embodiment, the method further comprises logging the redirected requests to access the first disk drive.

In another embodiment, the logged requests are stored with the second disk drive.

In another embodiment, the method further comprises processing the logged requests to the first disk drive in response to changing the firmware.

In one embodiment, a RAID storage system, comprises: a first disk drive designated for firmware modification; a proxy disk drive; and a storage controller coupled to the first disk drive and to the proxy disk drive and configured for copying data from the first disk drive to the proxy disk drive, for redirecting requests of the first disk drive to the proxy disk drive, and for changing firmware presently within the first disk drive.

In another embodiment, the RAID storage system further comprises a request log, wherein the storage controller is further configured to log redirected write requests in the request log.

In another embodiment, the request log is stored in the proxy disk drive.

### BRIEF DESCRIPTION OF THE DRAWINGS

FIG. 1 illustrates a block diagram of a RAID storage system capable of modifying firmware of a disk drive in an exemplary embodiment of the invention.

FIG. 2 illustrates a flowchart of an operation for modifying firmware of a disk drive performed by a RAID storage system in one exemplary embodiment of the invention.

### DETAILED DESCRIPTION OF THE DRAWINGS

While the invention is susceptible to various modifications and alternative forms, a specific embodiment thereof has been shown by way of example in the drawings and will herein be described in detail. It should be understood, however, that it is not intended to limit the invention to the particular form disclosed, but on the contrary, the invention is to cover all modifications, equivalents and alternatives falling within the spirit and scope of the invention as defined by the appended claims.

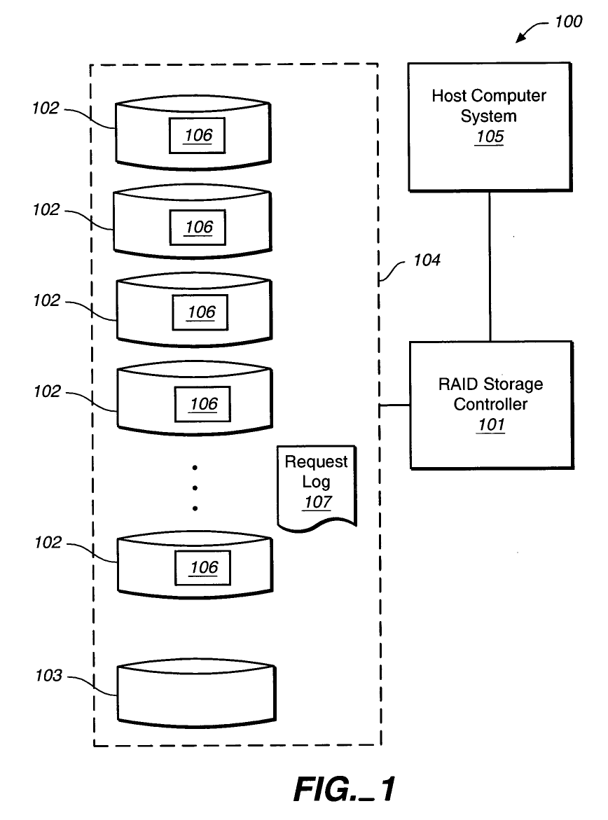

With reference now to the figures and in particular with reference to FIG. 1, an embodiment hereof is shown in a RAID storage system 100. RAID storage system 100 is configured for storing data on disk drives 102 using RAID storage management techniques to store the data and associated redundancy information distributed across disk drives 102. Disk drives 102 each contain firmware 106; the firmware of each drive may be used to control storage functionality of the disk drive. Design specifications may occasionally require that firmware 106 be altered to maintain storage performance and/or stability. Accordingly, when a change in functionality within storage system 100 is desired, certain features within firmware 106 may be changed to maintain an overall stability for storage system 100.

RAID storage system 100 includes RAID storage controller 101 configured for managing storage and retrieval of data on disk drives 102 and, among other things, changing firmware 106 within disk drives 102. Storage controller 101 is coupled to disk drives 102 and may also control access to disk drives 102. For example, storage system 100 may bundle a plurality of disk drives 102 into a JBOD 104 such that RAID storage controller 101 may interface to JBOD 104 and control direction of I/O requests made by host computer system 105. The I/O requests may be used to perform certain read and write operations upon the data stored within disk drives 102. Such an operation may be referred to as a standard mode of operation.

However, when a disk drive 102 is taken off-line for a firmware modification, RAID storage system 100 enters into a degraded mode of operation, leaving the storage system vulnerable to a data loss should redundant disk 102 within the system fail. To overcome such vulnerabilities, storage system 100 includes a proxy disk drive 103 used under control of controller 101 for copying stored data from a particular disk drive 102 while the firmware 106 of the particular disk drive 102 is changed. Disk drive 103 may be used to temporarily store data contained on one of the disk drives 102 while firmware 106 of the disk drive 102 is modified. RAID storage controller 101 may copy stored data on disk drive 102 to disk drive 103 to maintain and to ensure data integrity for storage system 100. For example, data integrity may be achieved because proxy disk drive 103, in containing the same data of the disk drive 102, can process I/O requests to that data as a substitute disk drive for the disk drive 102. After the data is copied from the disk drive 102 to disk drive 103 and the requests are directed to disk drive 103, disk drive 102 can, thus, be taken off-line to receive changes to firmware 106 via storage controller 101. Since RAID storage system 100 need not operate in a degraded mode where there is an increased risk of data loss due to potential redundant disk failures, the storage system may continue in a standard mode where data integrity is ensured and maintained.

Once data is copied from disk drive 102 to disk drive 103, storage controller 101 may disable disk drive 102 from receiving requests. As used herein, disabling of the disk drive refers to annotating information regarding the disk drive such that no control function outside firmware modification within storage controller 101 will attempt to use the disk drive. In addition, disabling the drive may be most useful where a plurality of storage controllers, such as controller 101, may share access to the disk drive. Disabling the disk drive in such a multiple controller application refers to sharing information as appropriate among the multiple controllers to assure that no other storage controller will attempt to utilize the disk drive while the firmware modification is underway.

Once disk drive 102 is disabled, storage controller 101 may begin altering firmware 106 within the disk drive 102. Any of numerous well known techniques to so modify the firmware 106 may be employed for this purpose. Often, firmware 106 of the disk drive 102 is stored in a flash memory or another programmable memory device such that new firmware information may be communicated from the storage controller 101 to control elements of the disk drive. The disk drive control element may then appropriately copy the downloaded information into its writable memory for firmware.

Once firmware modification is complete, data on disk drive 102 may be updated to reflect changes to the data as recorded on proxy disk 103 during the firmware modification period. The entire contents of proxy disk drive 103 may be copied to disk drive 102 in like manner by which data was copied to proxy disk drive 103. Alternatively, information regarding write requests processed during the firmware modification may be stored in a request log 107, discussed below herein.

Upon restoration or copying of updated data to disk drive 102, storage controller 101 may enable disk drive 102 to again receive I/O requests from host computer system 105 such that disk drive 102 returns to regular storage operations within storage system 100. As used herein, “enabling” the disk drive refers to indicating that the disk drive is again available for normal operation in conjunction with other associated disk drives in the array. As above with respect to disabling, enabling may entail exchanging messages among multiple storage controllers where multiple controllers share access to the disk drive 102.

In one embodiment, the proxy disk drive 103 may include a request log 107 that controller 101 may use to log write requests from host computer system 105 after the data is on disk drive 102 is copied to proxy disk drive 103. Such a request log 107 may record the affected region of the disk drive 102 being so modified. After completion of the firmware modification, storage controller 101 may process the logged write requests to disk drive 102. In addition, the request log 107 may be used for logging write requests intended for disk drive 102 during the copying of data from disk drive 102 to disk drive 103. This request log 107 may be used to log write requests to portions of disk drive 102 that have not presently been copied to proxy drive 103. For write requests directed to portions of disk drive 102 that have already been copied to proxy disk drive 103, storage controller 101 may direct the I/O requests to both disk drives until the data copy process is complete. Such a feature to copy data from one disk to another while continuing I/O request processing is described in the incorporated U.S. patent application Ser. No. 10/109,285. In another embodiment, the request log 107 may be stored in any other disk drives 102/103 not being firmware modified in storage system 100, preferably in such a manner to maintain required redundancy for reliability. For example, the request log 107 may be duplicated in a reserved portion of every disk drive 102 or may be distributed over the other disk drives 102 along with associated redundancy information. So long as the firmware modification did not modify the stored contents on the disk storage medium of drive 102, the request log 107 may be used to reduce the volume of information to be updated on disk drive 102. For example, data stored in disk drive 102 may then be updated only to the extent required as indicated by the logged requests. Such use of a request log 107 may substantially reduce the volume of information that needs updating following completion of the firmware modification. Details of logging, RAID regeneration, and disk copying techniques are generally known in the art and need not be further discussed herein.

While illustrated herein as a storage system 100 that enables firmware modifications to a disk drive 102 with a proxy disk drive 103, system 100 is not intended to be limited to the embodiment shown. For example, system 100 may include a plurality of proxy disk drives 103 each used to store data of a particular disk drive 102 during firmware modification. In such an embodiment, firmware modifications may be performed on a plurality of disk drives 102 in parallel. Additionally, the number of proxy drives 103 does not necessarily have to correspond to the number of disk drives 102. For example, one larger capacity proxy disk drive 103 may be used to store the data of multiple disk drives 102 and to receive redirected I/O requests intended for those disk drives 102 undergoing firmware modifications.

Moreover, although illustrated as coupled to one host computer system 105, system 100 is not intended to be limited to the embodiment shown. For example, RAID storage system 100 may be configured for receiving I/O requests from a plurality of host computers systems. Still further, any number of storage controllers may be present within the storage system 100 operating in parallel or merely serving as spare controllers (i.e., hot spare controllers) in case of failure of another storage controller.

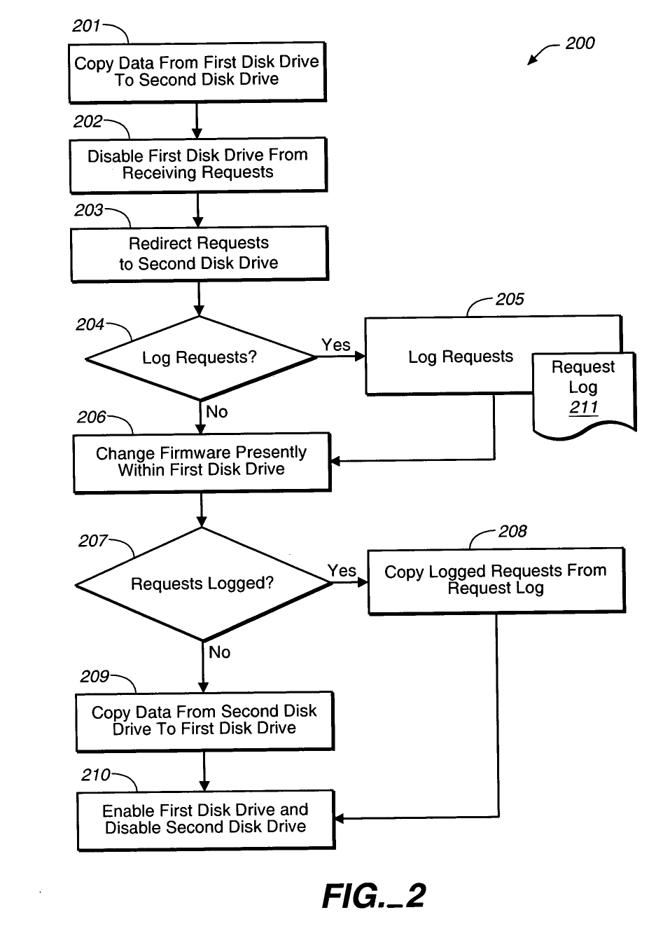

FIG. 2 is a flowchart showing one embodiment hereof for a method operable in a RAID storage system to enable firmware modification to disk drives within the storage system. In this embodiment, the storage system may enable such firmware modifications during storage operations, causing minimal degradation in storage functionality. The firmware modification process may begin by copying data from a first disk drive to a second disk drive, in element 201. Once data is copied, a storage controller, such as RAID storage controller 101 of FIG. 1, may disable the first disk drive from receiving requests until the firmware modification process is complete, in element 202. Requests intended for the first disk drive may be redirected to a second disk drive in response to copying the data, in element 203. The storage controller may decide whether the requests are to be logged, in element 204. A positive decision to log the request may result in the storage controller logging the requests in a request log 211, in element 205. Upon redirection and/or logging of the requests, the firmware presently within the first disk drive is changed, in element 206.

Once firmware is changed within the first disk drive, the storage system may determine a manner in which to reconstruct data on the first disk drive, in element 207. For example, if write requests were logged in request log 211, the system may process the logged requests to ensure the data of the first disk drive is current with respect to the logged requests, in element 208. If such write requests were not logged, changes in data relative to the data existing on the first disk drive may be copied from the second disk drive to the first disk drive, in element 209. After making the first disk drive consistent with the second disk drive via copying data from the second disk drive or via processing logged requests, the first disk drive may be enabled to again receive the requests, in element 210. As such, the second disk drive may perform as a proxy disk drive for the first disk drive until firmware modifications to the first disk drive can be completed.

Advantages of the above mentioned embodiments include the ability of the RAID storage system to maintain data availability and integrity during a firmware modification to one or more of the disk drives within the storage system. Features and aspects hereof obviate the need of past techniques to operate the system in RAID degraded mode during the modification of active disk drives in the storage system. Another advantage may include the ability of the storage system to include a proxy drive into a volume group if the disk drive fails during the firmware modification.

While the invention has been illustrated and described in the drawings and foregoing description, such illustration and description is to be considered as exemplary and not restrictive in character. One embodiment of the invention and minor variants thereof have been shown and described. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

1. A method of modifying firmware in a first disk drive of a RAID storage system, comprising:
copying data from the first disk drive to a second disk drive;
redirecting requests to access the first disk drive to the second disk drive in response to copying the data; and
changing firmware presently within the first disk drive in response to redirecting the requests.

2. The method of claim 1, further comprising disabling the first disk drive from processing the requests while changing the firmware.

3. The method of claim 2, further comprising enabling the first disk drive in response to changing the firmware.

4. The method of claim 3, further comprising stopping the redirecting of the requests to the second disk drive in response to enabling.

5. The method of claim 3, further comprising copying data from the second disk drive to the first disk drive in response to enabling the first disk drive.

6. The method of claim 1, further comprising logging the redirected requests to access the first disk drive.

7. The method of claim 6, wherein the logged requests are stored with the second disk drive.

8. The method of claim 6, further comprising processing the logged requests to the first disk drive in response to changing the firmware.

9. A RAID storage system, comprising:
a first disk drive designated for firmware modification;
a proxy disk drive; and
a storage controller coupled to the first disk drive and to the proxy disk drive and configured for copying data from the first disk drive to the proxy disk drive, for redirecting requests of the first disk drive to the proxy disk drive, and for changing firmware presently within the first disk drive.

10. The system of claim 9, further comprising a request log, wherein the storage controller is further configured to log redirected write requests in the request log.

11. The system of claim 10, wherein the request log is stored in the proxy disk drive.

12. A system for modifying firmware in a first disk drive of a RAID storage system, comprising:
means for copying data from the first disk drive to a second disk drive;
means for redirecting requests to access the first disk drive to the second disk drive responsive to the means for copying the data; and
means for changing firmware presently within the first disk drive responsive to the means for redirecting the requests.

13. The system for modifying of claim 12, further comprising means for disabling the first disk drive from processing the requests while changing the firmware.

14. The system for modifying of claim 13, further comprising means for enabling the first disk drive responsive to the means for changing the firmware.

15. The system for modifying of claim 14, further comprising means for stopping the redirecting of the requests to the second disk drive responsive to the means for enabling.

16. The system for modifying of claim 14, further comprising means for copying data from the second disk drive to the first disk drive responsive to the means for enabling the first disk drive.

17. The system for modifying of claim 12, further comprising means for logging the redirected requests to access the first disk drive.

18. The system for modifying of claim 17, wherein the logged requests are stored with the second disk drive.

19. The system for modifying of claim 17, further comprising means for processing the logged requests to the first disk drive responsive to the means for changing the firmware.
